(19) United States
(12) Patent Application Publication
(10) Pub. No.: US 2002/0027540 A1
(43) Pub. Date: Mar. 7, 2002

(54) Liquid crystal display device and driving method thereof

(76) Inventor: Moo Jin Lee, Daegu-shi (KR)

Correspondence Address: LONG ALDRIDGE & NORMAN LLP, Suite 600, 701 Pennsylvania Avenue, N.W., Washington, DC, 20004, US

(21) Appl. No.: 09/892,662

(22) Filed: Jun. 28, 2001

(30) Foreign Application Priority Data
Sep. 2, 2000 (KR) P2000-51886

(51) Int. Cl. G09G 3/36

(52) U.S. Cl. 345/87

(57) ABSTRACT

A liquid crystal display device and a driving method thereof wherein a change in a charge rate of a thin film transistor compensates for an externally applied frequency variation upon driving of the liquid crystal display device so as to improve the picture quality. In the device, a timing controller receiving control signals from a host system. A frequency detector is connected to either the input terminal or the output terminal of the timing controller to detect the control signals. A compensation voltage setting part compensates for the driving voltage in response to the control signals detected from the frequency detector so as to adjust a charge time of each thin film transistor. A digital to digital converter generates a compensation voltage set by the compensation voltage setting part to deliver the compensation voltage to a liquid crystal display panel. Accordingly, the common voltage and/or the gate high voltage, changed in accordance with an extremely applied frequency variation, are set to optimum values and thus are compensated so that a constant picture quality can be maintained irrespectively of such a frequency variation.

### CROSS REFERENCES TO RELATED APPLICATIONS

This application claims benefit of Korean Patent Application No. P2000-51886, filed on Sep. 2, 2000, the entirety of which is hereby incorporated by reference for all purposes as if fully set forth herein.

### BACKGROUND OF THE INVENTION

1. Field of the Invention

This invention relates to a liquid crystal display (LCD), and more particularly to a liquid crystal display device wherein a change in a charge rate of a thin film transistor is compensated in a frequency variation applied from the exterior thereof upon driving of the liquid crystal display device so as to improve a picture quality. The present invention also is directed to a method of driving said liquid crystal display device.

2. Description of the Related Art

Generally, a liquid crystal display device has an inherent resolution corresponding to the number of integrated pixels, and has a higher resolution as its dimension becomes larger. In order to display a high quality of picture, makers of the liquid crystal display device increase a pixel integration ratio within a liquid crystal panel among liquid crystal display devices having the same dimension for the purpose of differentiating the resolution.

The standards of image signals and control signals in the case of a personal computer, etc., including the liquid crystal display device along with the resolution were established by the Video Electronics Standard Association (VESA) in February 1989.

The typical standards of display devices being commercially available in the current display industry include DOS Mode (640×350, 640×400, 720×400), VGA (640×400), SVGA (800×600), XGA (1024×768), SXGA (1280×1024) and UXGA (1600×1200) Modes, etc.

The LCD has a resolution fixed depending on the number of arranged pixels and hence requires image signals conforming to a resolution of the liquid crystal display panel and control signals for the image signal from the system. Accordingly, the system converts image signals and control signals corresponding to various display standards into image signals and control signals complying with a resolution and a display standard of the LCD using a scaler chip and the like and applies the same to the LCD.

FIG. 1 is a block diagram showing a configuration of the conventional LCD. In FIG. 1, an interface 10 receives data (e.g., RGB data) and control signals (e.g., an input clock, a horizontal synchronizing signal, a vertical synchronizing signal and a data enable signal) and applies them to a timing controller 12. A low voltage differential signal (LVDS) interface and a transistor transistor logic (TTL) interface, etc., have been mainly used for data and control signal transmission to the driving system. All of such interfaces are integrated into a single chip along with the timing controller 12.

The timing controller 12 uses a control signal input via the interface 10 to produce control signals for driving a data driver 18 consisting of a plurality of driver ICs (not shown) and a gate driver 20 consisting of a plurality of gate driver ICs (not shown). Also, the timing controller 12 transfers data input from the interface 10 to the data driver 18.

The data driver 18 selects reference voltages in accordance with the input data in response to control signals from the timing controller 12 to convert the same into an analog image signal and applies the converted signal to a liquid crystal panel 22. The gate driver 20 performs an on/off control of gate terminals of thin film transistors (TFTs) arranged on the liquid crystal panel 22, one line by one line, in response to the control signals input from the timing controller 12. Also, the gate driver 20 allows the analog image signals from the data driver 18 to be applied to each pixel connected to each TFT.

A direct current (DC) voltage to DC voltage converter 14 applies a gate high voltage (Vgh) for driving the TFTs within the liquid crystal display panel 22 to the gate driver 20, and generates a common electrode voltage Vcom for the liquid crystal display panel 22 to apply it to the gate driver 20. The standards of said voltages are established by a manufacturer on the basis of the transmissivity to voltage characteristic of the panel.

However, the LCD also has employed various display formats from the VGA class to the UXGA class. Signals input to the timing controller differ depending on the various display formats. In other words, a main clock or a frame frequency input to the interface is different depending on various display formats set in accordance with the resolution. Accordingly, a charge characteristic of the TFT provided within the liquid crystal display panel becomes different, and hence flicker and gray scale characteristics, etc. becomes different, to thereby change a picture quality.

This will be described by an example shown in FIG. 2. In FIG. 2, when a gate high voltage (Vgh) applied to the TFT has a constant value of 18V, a common voltage Vcom also has a constant value of 5V and a frame frequency is changed from 50 Hz to 60 Hz, a charge time T of the TFT is decreased from 22 μs (T1) to 18 μs (T2) and, at the same time, a gate voltage width Gw is decreased from Gw1 to Gw2. Thus, a data pulse applied to the TFT fails to reach a saturation state to cause a discharge. Therefore, the TFT fails to make a sufficient discharge to reduce the charge rate and generate a variation in a picture quality.

As described above, the conventional LCD applies a constant high voltage Vgh and a constant common electrode voltage Vcom from the DC to DC voltage converter to the TFT's provided within the liquid crystal display panel even though a main clock or a frame frequency differ in accordance with various display formats set depending on the resolution that is input thereto. Thus, a charge rate of the TFT is changed and a flicker, etc. is generated, to thereby cause a deterioration of picture quality.

### SUMMARY OF THE INVENTION

Accordingly, it is an object of the present invention to provide a liquid crystal display device and a driving method thereof wherein a change in a charge rate of a thin film transistor is compensated for a frequency variation applied from the exterior thereof upon driving of the liquid crystal display device so as to improve a picture quality.

In order to achieve these and other objects of the invention, a liquid crystal display device according to one aspect of the present invention includes a timing controller for receiving control signals transmitted from a host system; a frequency detector connected to either an input terminal or an output terminal of the timing controller to detect the transmitted control signals; compensation voltage setting means for compensating the driving voltage in response to the control signals detected from the frequency detector so as to assure a charge time of each thin film transistor; and a digital to digital converter for generating a compensation voltage set by the compensation voltage setting means to deliver the compensation voltage to a liquid crystal display panel.

A method of controlling a liquid crystal display device according to another aspect of the present invention includes the steps of detecting control signals from any one of an input terminal and an output terminal of a timing controller receiving the control signals from a host system; setting a compensation voltage for compensating the driving voltage in response to the detected control signals so as to assure a charge time of each thin film transistor; and generating the set compensation voltage to deliver it to a liquid crystal display panel.

### BRIEF DESCRIPTION OF THE DRAWINGS

These and other objects of the invention will be apparent from the following detailed description of the embodiments of the present invention with reference to the accompanying drawings, in which:

FIG. 1 is a block diagram showing a configuration of a conventional liquid crystal display device;

FIG. 2 illustrates the time-varying amplitude of a gate high voltage and a common electrode voltage applied to the TFT in FIG. 1;

FIG. 3 is a schematic block diagram showing a configuration of a driving circuit for a liquid crystal display device according to a first embodiment;

FIG. 4 is a schematic block diagram showing a configuration of a driving circuit for a liquid crystal display device according to a second embodiment;

FIG. 5 is a graph for explaining a TFT charge compensation employing the driving circuits shown in FIG. 3 and FIG. 4;

FIG. 6 is a schematic block diagram showing a configuration of a driving circuit for a liquid crystal display device according to a third embodiment;

FIG. 7 is a schematic block diagram showing a configuration of a driving circuit for a liquid crystal display device according to a fourth embodiment;

FIG. 8 is a graph for explaining a TFT charge compensation employing the driving circuits shown in FIG. 6 and FIG. 7;

FIG. 9 is a schematic block diagram showing a configuration of a driving circuit for a liquid crystal display device according to a fifth embodiment;

FIG. 10 is a schematic block diagram showing a configuration of a driving circuit for a liquid crystal display device according to a sixth embodiment; and

FIG. 11 is a graph for explaining a TFT charge compensation employing the driving circuits shown in FIG. 9 and FIG. 10.

### DETAILED DESCRIPTION OF THE PREFERRED EMBODIMENTS

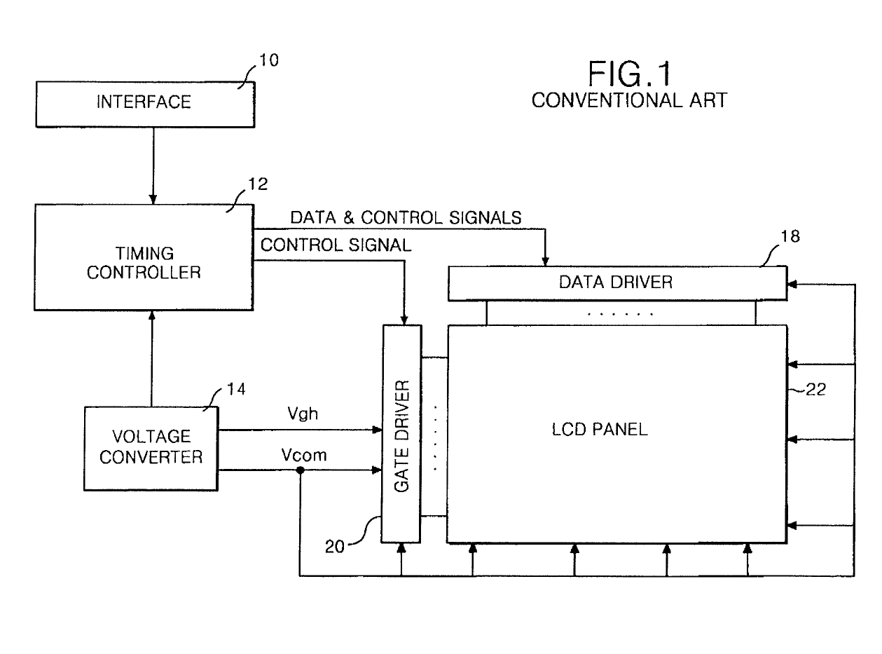

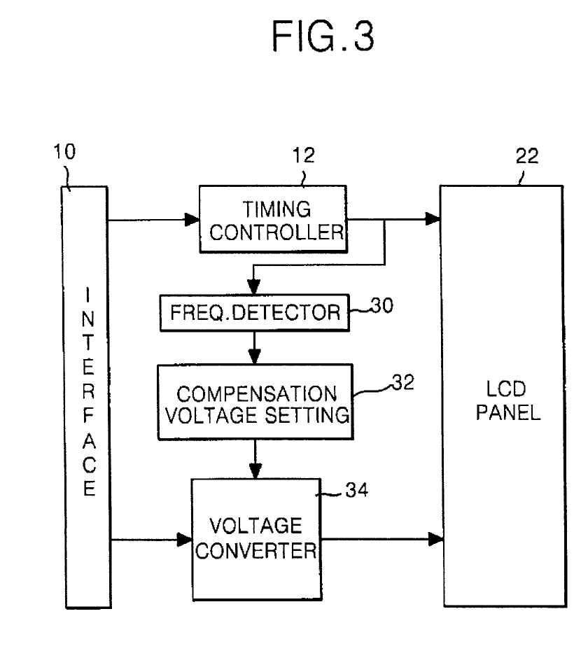

FIG. 3 is a block diagram of a driving circuit for a liquid crystal display device according to a first embodiment. The interface, the timing controller, the digital to digital converter and the liquid crystal display panel in FIG. 3 are identical to those of the driving circuit in FIG. 1. Therefore, said elements in FIG. 3 are given by the same reference numerals as those in FIG. 1.

Referring to FIG. 3, the liquid crystal display device according to the first embodiment includes an interface 10 for receiving and transferring data (e.g., RGB data) and control signals (e.g., an input clock, a horizontal synchronizing signal, a vertical synchronizing signal and a data enable signal) input from a driving system such as a personal computer, a timing controller 12 for generating control signals for driving a data driver 18 consisting of a plurality of data driving ICs (not shown) and a gate driver 20 consisting of a plurality of gate driving ICs (not shown) using the control signals input via the interface 10, a frequency detector 30 for detecting frequencies of the control signals output to the output terminal of the timing controller 12, a compensation voltage setting part 32 for retrieving and comparing the frequencies detected from the frequency detector 30 to generate a control signal for setting a compensation voltage according to said frequencies, a digital to digital converter 34 for generating a desired gate high voltage Vgh for raising and lowering a reference voltage Vin from the interface 10 using the control signal from the compensation voltage setting part 32 to deliver the same to the gate driver, and a liquid crystal display panel 22 driven with the gate high voltage Vgh and a data signal applied from the gate driver 20 and the data driver 18, respectively.

The frequency detector 30 receives the control signals (e.g., a vertical synchronizing signal and a data signal) from the timing controller 12 via an output transmission line of the timing controller 12 and sends them to the compensation voltage setting part 32. The compensation voltage setting part 32 retrieves the control signals from the frequency detector 30, and generates a control signal for setting a compensation voltage for the gate high voltage Vgh so as to sufficiently drive the TFTs provided within the liquid crystal display panel 22 in response to the retrieved control signals to deliver the same to the digital to digital converter 34. The digital to digital converter 34 raises or lowers a reference voltage Vin from the interface 10 by the control signal from the compensation voltage setting part 32 to generate a compensation voltage sufficient to drive the TFTs, and delivers the compensation voltage to the liquid crystal display panel 22.

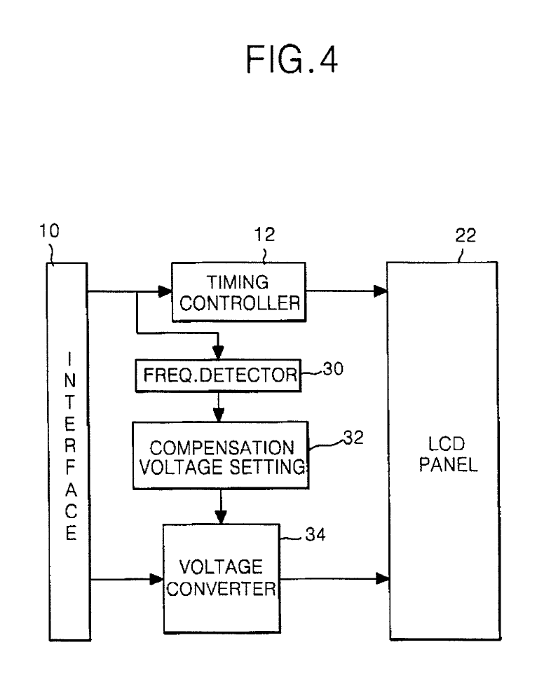

FIG. 4 is a block diagram of a driving circuit for a liquid crystal display device according to a second embodiment. The driving circuit in FIG. 4 has the same driving characteristic as that in FIG. 3. except that the frequency detector detects the control signals input to the timing controller from the input terminal of the timing controller rather than detecting the control signals from the output terminal of the timing controller.

Since the driving circuit for the liquid crystal display device according to the second embodiment shown in FIG. 4 has the same driving characteristic as the driving circuit shown in FIG. 3, a detailed explanation as to the driving circuit for the liquid crystal display device according to the second embodiment will be omitted.

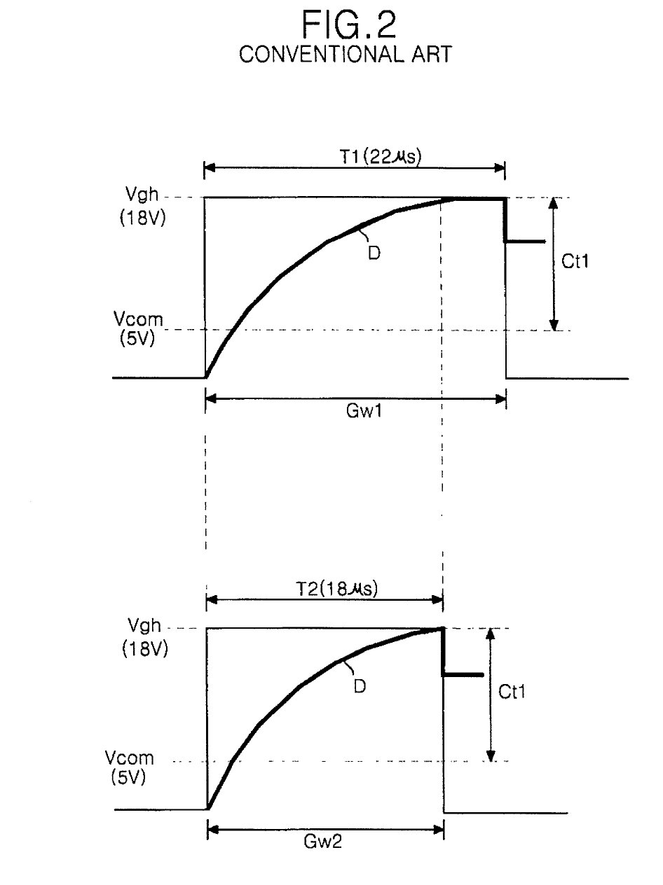

Driving characteristics of the driving circuits for the liquid crystal display devices shown in FIG. 3 and FIG. 4 will be described in conjunction with an example shown in FIG. 2 below.

As shown in FIG. 2, when a gate high voltage (Vgh) is 18V, a common voltage Vcom is 5V and a frame frequency of 50 Hz set to achieve an optimum charge characteristic is changed into 60 Hz, a charge time T of the TFT is decreased from 22 μs (T1) to 18 μs (T2) and, at the same time, a gate voltage width Gw is decreased from Gw1 into Gw2. Thus, a time period for sufficiently charging the TFT is reduced.

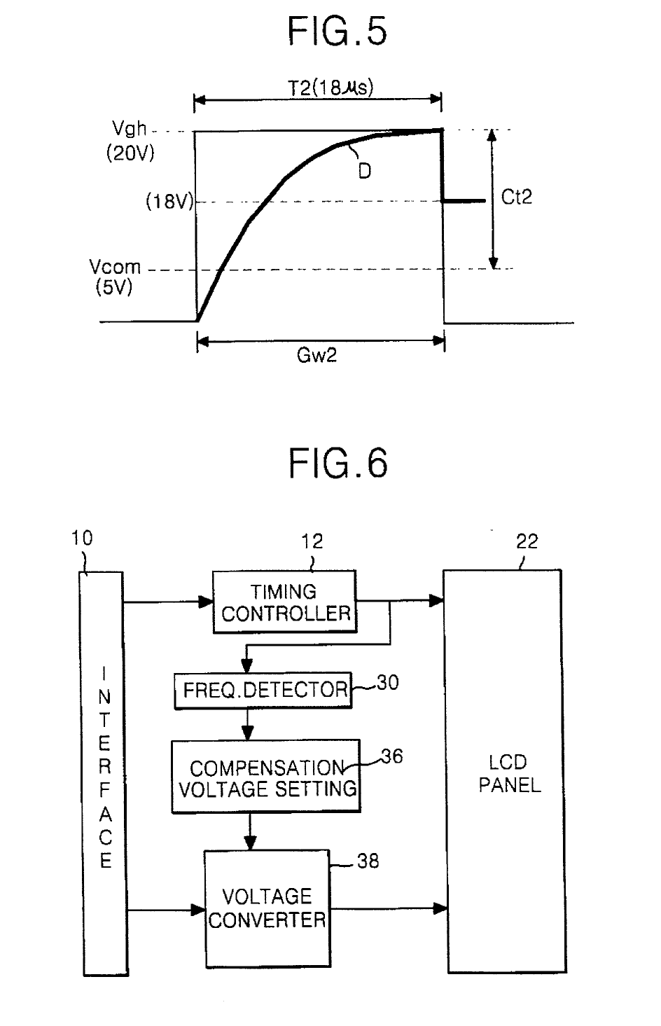

In order to solve this problem, the frequency detector 30 as shown in FIG. 3 or FIG. 4 detects the control signals input to or output from the timing controller 12 and delivers the detected control signals to the compensation voltage setting part 32. The compensation voltage setting part 32 sets an appropriate compensation voltage so that the TFT can obtain an optimum charge rate, as shown in FIG. 5. In this case, the charge rate of the TFT is compensated by increasing the gate high voltage Vgh to 20V. In other words, the gate high voltage Vgh is increased to lengthen a charged region Ct2. Accordingly, the charged region Ct2 of the TFT is sufficiently lengthened, so that an optimum charge rate can be obtained.

FIG. 6 is a block diagram of a driving circuit for a liquid crystal display device according to a third embodiment. The driving circuit in FIG. 6 has the same driving characteristic as that in FIG. 3. except that the compensation voltage setting part sets a compensation voltage for compensating for a common voltage Vcom and the digital to digital converter generates the compensation voltage set by the compensation voltage setting part to apply it to the liquid crystal display panel. Therefore, only the compensation voltage setting part and the digital to digital converter being different from those in FIG. 3 will be described.

As shown in FIG. 6, the compensation voltage setting part 36 retrieves control signals from the frequency detector 30, and generates a control signal for setting a compensation voltage for a common voltage Vcom so as to sufficiently drive the TFTs provided within the liquid crystal display panel 22 in response to the retrieved control signals to deliver the same to a digital to digital converter 38. The digital to digital converter 38 raises or lowers a reference voltage Vin from the interface 10 by the control signal from the compensation voltage setting part 32 to generate a compensation voltage sufficient to drive the TFTs, and delivers the compensation voltage to the liquid crystal display panel 22.

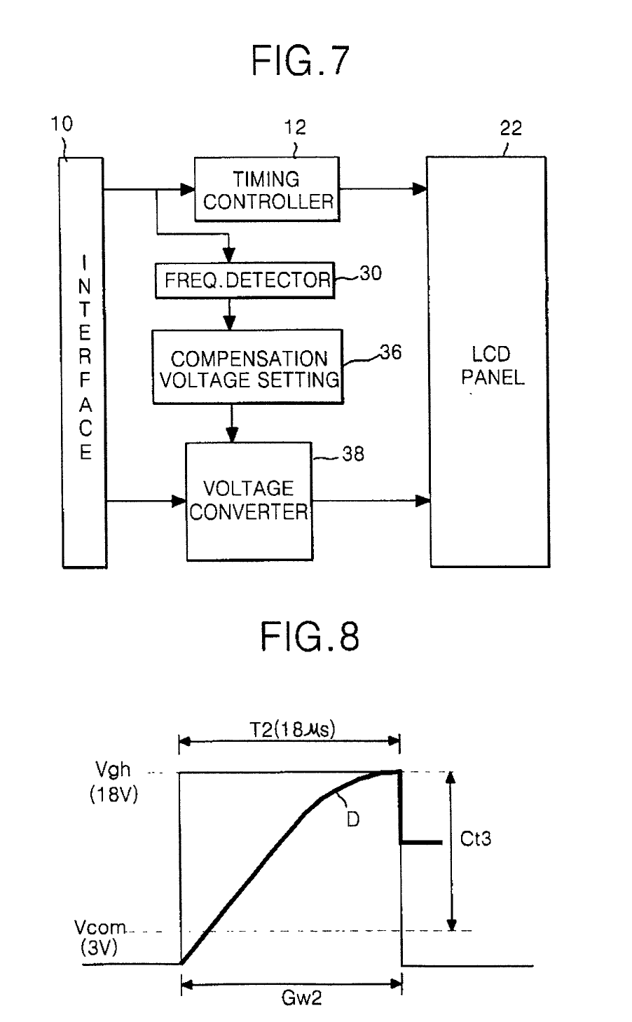

FIG. 7 is a block diagram of a driving circuit for a liquid crystal display device according to a fourth embodiment. The driving circuit in FIG. 7 has the same driving characteristic as that in FIG. 6. except that the frequency detector detects the control signals inputted to the timing controller from the input terminal of the timing controller rather than detecting the control signals from the output terminal of the timing controller.

Since the driving circuit for the liquid crystal display device according to the fourth embodiment shown in FIG. 6 has the same driving characteristic as the driving circuit shown in FIG. 6, a detailed explanation as to the driving circuit for the liquid crystal display device according to the fourth embodiment will be omitted.

Driving characteristics of the driving circuits for the liquid crystal display devices shown in FIG. 6 and FIG. 7 will be described in conjunction with an example shown in FIG. 2 below.

As shown in FIG. 2, when a gate high voltage (Vgh) is 18V, a common voltage Vcom is 5V and a frame frequency of 50 Hz set to achieve an optimum charge characteristic is changed into 60 Hz, a charge time T of the TFT is decreased from 22 μs (T1) to 18 μs (T2) and, at the same time, a gate voltage width Gw is decreased from Gw1 to Gw2. Thus, the time for sufficiently charging the TFT is reduced.

In order to solve this problem, the frequency detector 30 as shown in FIG. 6 or FIG. 7 detects the control signals input to, or output from, the timing controller 12 and delivers the detected control signals to the compensation voltage setting part 36. The compensation voltage setting part 36 sets an appropriate compensation voltage so that the TFT can obtain an optimum charge rate as shown in FIG. 8. In this case, the charge rate of the TFT is compensated by decreasing the common voltage Vcom to 3V. In other words, the common voltage Vcom is reduced to lengthen a region Ct3. Accordingly, the charged region Ct3 of the TFT is sufficiently lengthened, so that an optimum charge rate can be obtained.

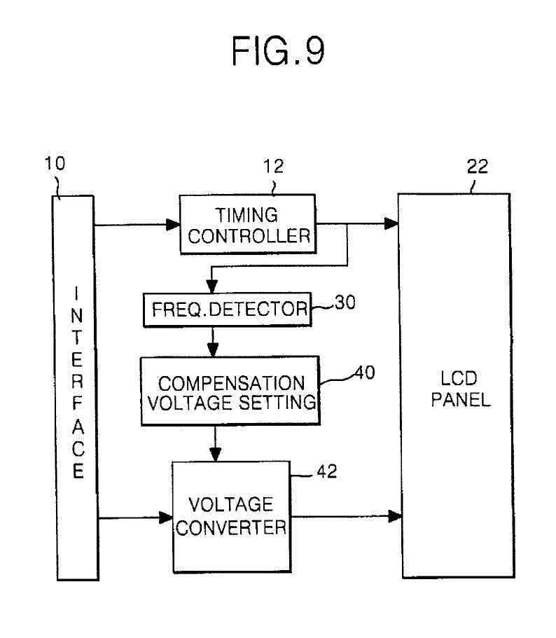

FIG. 9 is a block diagram of a driving circuit for a liquid crystal display device according to a fifth embodiment of the present invention. The driving circuit in FIG. 9 has the same driving characteristic as that in FIG. 3 or FIG. 6, except that the compensation voltage setting part sets a compensation voltage for compensating for a gate high voltage Vgh and a common voltage Vcom and the digital to digital converter generates the compensation voltage set by the compensation voltage setting part to apply it to the liquid crystal display panel. Therefore, only the compensation voltage setting part and the digital to digital converter being different from those in FIG. 3 or FIG. 6 will be described.

As shown in FIG. 9, the compensation voltage setting part 40 retrieves control signals from the frequency detector 30, and generates a control signal for setting a compensation voltage for a gate high voltage Vgh and a common voltage Vcom so as to sufficiently drive the TFTs provided within the liquid crystal display panel 22 in response to the retrieved control signals to deliver the same to a digital to digital converter 42. The digital to digital converter 42 heightens and/or lowers a reference voltage Vin from the interface 10 by the control signal from the compensation voltage setting part 40 to generate a compensation voltage enough to drive the TFTs, and delivers the compensation voltage to the liquid crystal display panel 22.

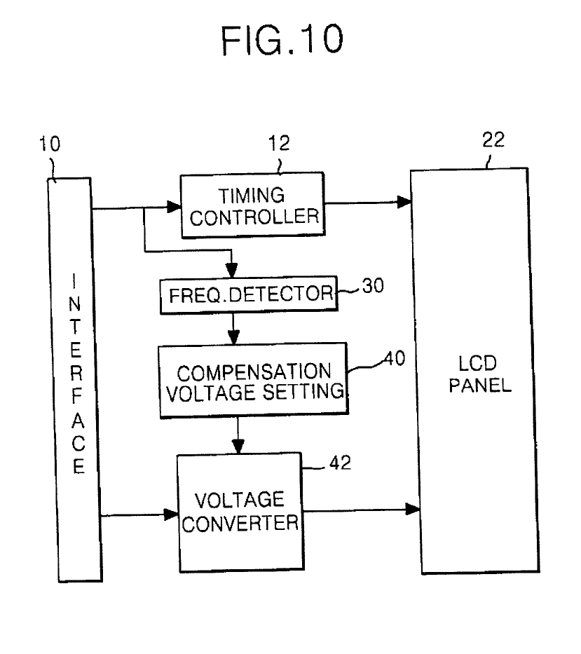

FIG. 10 is a block diagram of a driving circuit for a liquid crystal display device according to a sixth embodiment of the present invention. The driving circuit in FIG. 10 has the same driving characteristic as that in FIG. 9, except that the frequency detector detects the control signals input to the timing controller from the input terminal of the timing controller rather than detecting the control signals from the output terminal of the timing controller.

Since the driving circuit for the liquid crystal display device according to the sixth embodiment shown in FIG. 10 has the same driving characteristic as the driving circuit shown in FIG. 9, a detailed explanation as to the driving circuit for the liquid crystal display device according to the sixth embodiment will be omitted.

Driving characteristics of the driving circuits for the liquid crystal display devices shown in FIG. 9 and FIG. 10 will be described in conjunction with an example shown in FIG. 2 below.

As shown in FIG. 2, when a gate high voltage (Vgh) is 18V, a common voltage Vcom is 5V and a frame frequency of 50 Hz set to achieve an optimum charge characteristic is changed into 60 Hz, a charge time T of the TFT is decreased from 22 μs (T1) to 18 μs (T2) and, at the same time, a gate voltage width Gw is decreased from Gw1 to Gw2. Thus, a time for sufficiently charging the TFT is reduced.

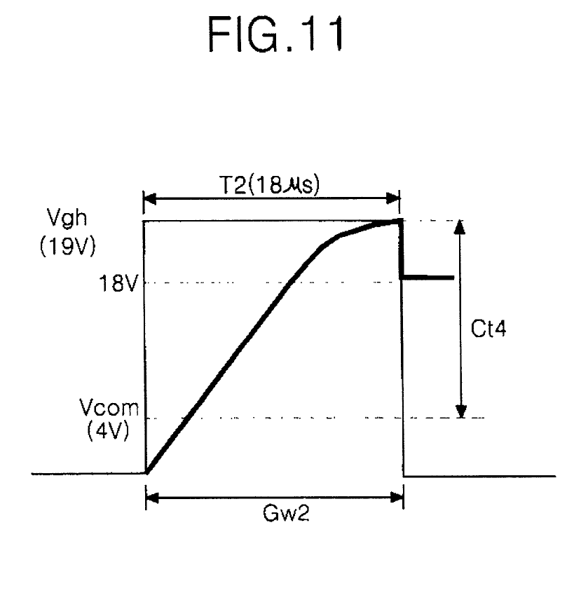

In order to solve this problem, the frequency detector 30 as shown in FIG. 9 or FIG. 10 detects the control signals input to or output from the timing controller 12 and delivers the detected control signals to the compensation voltage setting part 40. The compensation voltage setting part 40 sets an appropriate compensation voltage so that the TFT can obtain an optimum charge rate as shown in FIG. 11. In this case, the charge rate of the TFT is compensated by resetting the gate high voltage Vgh to 19V and the common voltage Vcom to 3V. In other words, the gate high voltage Vgh is heightened while the common voltage Vgh is lowered to lengthen a charged region Ct4. Accordingly, the charged region Ct4 of the TFT is sufficiently lengthened, so that an optimum charge rate can be obtained.

As described above, according to the present invention, the common voltage and/or the gate high voltage, changed in accordance with an extremely applied frequency variation, are set to optimum values and thus are compensated so that a constant picture quality can be maintained irrespectively of such a frequency variation.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A liquid crystal display device including a liquid crystal display panel provided with thin film transistors driven with control signals and a driving voltage applied from a host system, said device comprising:
a timing controller having an input terminal for receiving the control signals transmitted from the host system and having an output terminal;
a frequency detector connected to any one of the input terminal or the output terminal of the timing controller to detect the transmitted control signals;
compensation voltage setting means for compensating the driving voltage in response to the control signals detected by the frequency detector so as to adjust a charge time of the thin film transistors; and
a digital to digital converter for generating a compensation voltage set by the compensation voltage setting means to deliver the compensation voltage to the liquid crystal display panel.

2. The liquid crystal display device as claimed in claim 1, wherein said compensation voltage is any one of a gate high voltage and a common voltage of the thin film transistors.

3. The liquid crystal display device as claimed in claim 1, wherein said compensation voltage includes a gate high voltage and a common voltage of the thin film transistor.

4. A method of controlling a liquid crystal display device including a liquid crystal display panel provided with thin film transistors driven with control signals and a driving voltage applied from a host system, said method comprising:
detecting the control signals from any one of an input terminal and an output terminal of a timing controller receiving the control signals from the host system;
setting a compensation voltage for compensating the driving voltage in response to the detected control signals so as to adjust a charge time of the thin film transistors; and
generating the set compensation voltage to deliver it to the liquid crystal display panel.

5. The method as claimed in claim 4, wherein said compensation voltage is any one of a gate high voltage and a common voltage of the thin film transistor.

6. The method as claimed in claim 4, wherein said compensation voltage includes a gate high voltage and a common voltage of the thin film transistor.

7. A liquid crystal display (LCD) device, comprising:
an LCD panel including,
a plurality of pixels arranged in a matrix, each pixel having a corresponding switching device,
a plurality of data lines connected to the switching devices for providing pixel data thereto, and
a plurality of scanning lines for applying scanning signals to control the switching devices;
a timing controller receiving external control signals and controlling a timing of scanning signals;
a frequency detector detecting a frequency of at least one of the external control signals;
a voltage compensator receiving the detected frequency and generating therefrom a compensation voltage control signal; and
a voltage converter receiving the compensation voltage control signal and a reference voltage for driving the scanning lines of the LCD panel and in response thereto generating a compensated driving voltage for driving the scanning lines of the LCD panel.

8. The LCD device of claim 7, wherein the compensated driving voltage includes a high voltage level of the scanning signals.

9. The LCD device of claim 7, wherein the compensated driving voltage includes a common voltage level of the scanning lines.

10. The LCD device of claim 7, wherein the compensated driving voltage includes a high voltage level and a common voltage level of the scanning lines.

11. The LCD device of claim 7, wherein the frequency detector directly detects the frequency of the external control signals applied to the timing controller.

12. The LCD device of claim 7, wherein the frequency detector detects a frequency of the control signals by detecting a corresponding frequency of an output signal of the timing controller.

13. A method of driving a liquid crystal display device comprising an LCD panel including a plurality of pixels arranged in a matrix, each pixel having a corresponding switching device, a plurality of data lines connected to the switching devices for providing pixel data thereto and a plurality of scanning lines for applying scanning signals to control the switching devices, the method comprising:
receiving external control signals for controlling a timing of scanning signals;
detecting a frequency of at least one of the external control signals;
generating a compensation voltage control signal according to the detected frequency; and
employing the compensation voltage control signal to generate a compensated driving voltage for driving the scanning lines of the LCD panel.

14. The method of claim 13, wherein the compensated driving voltage includes a high voltage level of the scanning signals.

15. The method of claim 13, wherein the compensated driving voltage includes a common voltage level of the scanning lines.

16. The method of claim 13, wherein the compensated driving voltage includes a high voltage level and a common voltage level of the scanning lines.

17. The method of claim 13, wherein employing the compensation voltage control signal to generate a compensated driving voltage for driving the scanning lines of the LCD panel comprises one of raising or lowering a high voltage level of the scanning signals.

18. The method of claim 13, wherein employing the compensation voltage control signal to generate a compensated driving voltage for driving the scanning lines of the LCD panel comprises one of raising or lowering a common voltage level of the scanning signals.

19. The method of claim 13, wherein employing the compensation voltage control signal to generate a compensated driving voltage for driving the scanning lines of the LCD panel comprises:
one of raising or lowering a high voltage level of the scanning signals; and
one of raising or lowering a common voltage level of the scanning signals.
